(19) United States
(12) Patent Application Publication
(10) Pub. No.: US 2008/0294558 A1
(43) Pub. Date: Nov. 27, 2008

(54) PORTABLE ELECTRONIC APPLIANCE, DATA PROCESSOR, DATA COMMUNICATION SYSTEM, COMPUTER PROGRAM, DATA PROCESSING METHOD

(76) Inventors: Masahiro Shimanuki, Tokyo (JP); Kousuke Yamamoto, Tokyo (JP)

Correspondence Address: NEC CORPORATION OF AMERICA, 6535 N. STATE HWY 161, IRVING, TX, 75039, US

(21) Appl. No.: 12/125,523

(22) Filed: May 22, 2008

(30) Foreign Application Priority Data
May 23, 2007 (JP) 2007-136439

(51) Int. Cl. G06Q 20/00; G06F 1/00

(52) U.S. Cl. 705/44; 713/310; 705/39

(57) ABSTRACT

Aimed at providing a portable electronic appliance and a data processor capable of preventing stealing of electricity, a mobile phone terminal, which is a portable electronic appliance of the present invention supplied with electric power from the specific commercial power source, is brought into functional interruption by a data processor, the data processor executes account settlement of supplied power while keeping the mobile phone terminal in functional interruption, and upon completion of the account settlement, the data processor unlocks the functional interruption of the mobile phone terminal, so that an authorized contractor of the commercial power source is prevented from being unreasonably charged with power rate charged up in the mobile phone terminal, and stealing of electricity by the user of the mobile phone terminal may be avoidable.

This application is based on Japanese patent application No. 2007-136439 filed May 23, 2007, the content of which is incorporated hereinto by reference.

### BACKGROUND

1. Technical Field

The present invention relates to a portable electronic appliance made functional after being charged with electric power, data processor establishing data communication at least with a portable electronic appliance, a data communication system composed of a portable electronic appliance and a data processor, a computer program used for the portable electronic appliance and the data processor, and a data processing method.

2. Related Art

Conventionally, so-called mobile phone terminal and so forth have generally been disseminated as portable electronic appliance made functional after being charged with electric power. This sort of mobile phone terminal has a secondary battery and a data processing circuit incorporated therein.

The secondary battery is charged with electric power supplied from an external commercial power source, and the data processing circuit functions using thus charged electric power. When the mobile phone terminal is charged with electric power, the mobile phone terminal is plugged into a power source receptacle using a separately available power source adapter.

In other words, the mobile phone terminal may be chargeable at any place where the power source receptacle is available, so far as the power source adapter is carried therewith. This has raised a problem of stealing of electricity, which is an inappropriate way of charging the mobile phone terminal by unplugging a power source plug of an automatic vending machine from a power source receptacle, and instead connecting the power source adapter to the power source receptacle.

Aiming at preventing such stealing of electricity, there has been a proposal on an electric power supply system which supplies electric power through a power line to the mobile phone terminal when the mobile phone terminal is connected thereto, configured so as to acquire authentication data from the mobile phone terminal by power line communication (see Japanese Laid-Open Patent Publication No. 2006-094655).

This electric power supply system generates an account data based on the authentication data acquired from the mobile phone terminal. Based on the account data, the user of the mobile phone terminal is asked for a power rate. The system can also subtract the power rate called upon the external user from the power rate called upon a contractor of the power supply system, so that the authorized user is prevented from being asked for the power rate ascribable to the external user.

When the authentication data was acquired from a portable electronic appliance of the authorized user of the automatic vending machine, the above-described power supply system recognizes based on the authentication data that the user was the authorized contractor. In this way, the authorized contractor is prevented from being asked for any unreasonable rate.

The above-described power supply system also interrupts power supply, unless the authentication data acquired from the mobile phone terminal is authenticated. Therefore, the system can also prevent power supply to the user upon whom power rate cannot be called.

The above-described power supply system, however, interrupts power supply, when it fails in acquiring the authentication data from the portable electronic appliance connected to the power line, and fails in authenticating the user. This means that only specially-designed electric appliances, capable of sending the authentication data by power line communication, may be connectable to the power source receptacle.

For this reason, even the authorized contractor cannot use general electric appliances, incapable of sending user information by power line communication, by connecting them to the above-described power supply system. In short, the power supply system is limited only to special applications.

The above-described power supply system needs control of power supply, for the purpose of effectively preventing stealing of electricity. Therefore, a dedicated facility capable of controlling power supply is necessary. It is also anticipated that power supply may unnecessarily be interrupted due to detection error.

The present invention was conceived after considering the above-described problems, and is to provide a portable electronic appliance and a data processor allowing use of general electronic appliances as being connected to a commercial power source without causing any problems, and is capable of preventing stealing of electricity by unauthorized portable electronic appliances, a data communication system composed of such portable electronic appliance and such data processor, and a computer program and a data processing method applicable to the portable electronic appliance and to the data processor.

### SUMMARY

According to the present invention, there is provided a portable electronic appliance made functional after being charged with electric power, which includes a battery-powered functional unit made functional after being charged with electric power supplied from an external commercial power source; a data receiving unit receiving, from an external specific data processor, at least a function interrupting command for the battery-powered functional unit, when electric power is supplied from the specific commercial power source; a function interrupting unit interrupting at least a part of functions of the battery-powered functional unit upon receiving of the function interrupting command; an account settlement accepting unit executing account settlement of supplied power, while keeping the battery-powered functional unit in functional interruption; and an interruption unlock unit unlocking functional interruption of the battery-powered functional unit upon completion of the account settlement.

Accordingly, in the portable electronic appliance of the present invention, the battery-powered functional unit functions after being charged with electric power supplied from the commercial power source. In the process of power supply herein from the specific commercial power source, when the data receiving unit receives the function interrupting command from the external specific data processor, the function interrupting unit interrupts at least a part of functions of the battery-powered functional unit. While keeping the battery-powered functional unit in functional interruption in this way, the account settlement accepting unit executes account settlement of supplied power. Upon completion of the account settlement, the interruption unlock unit unlocks functional interruption of the battery-powered functional unit. In other words, the battery-powered functional unit is in functional interruption when electric power is supplied from the specific commercial power source, and the functional interruption is not unlocked until the account is settled. The above-described functional interruption is a special function of the portable electronic appliance of the present invention. By virtue of this function, if the general electric appliances are connected to the above-described specific commercial power source, they will not be interrupted by the data processor.

The data processor of the present invention is a processor establishing data communication at least with a portable electronic appliance, which includes a data sender unit sending at least a function interrupting command to the portable electronic appliance supplied with electric power from a specific commercial power source; and an account settlement executing unit executing account settlement of supplied power for the portable electronic appliance to which the function interrupting command was sent.

Accordingly, in the data processor of the present invention, the data sender unit sends at least a function interrupting command to the portable electronic appliance supplied with electric power from the specific commercial power source. The portable electronic appliance, to which the function interrupting command was sent, and the account settlement executing unit execute account settlement. Therefore, the account is settled while interrupting functions of the specific portable electronic appliance to which electric power is supplied from the specific commercial power source. The functional interruption is executed only for the specific portable electronic appliance corresponded to a predetermined function interrupting command. As a consequence, functions of the general electric appliances will never be interrupted by the data processor, even if they were connected to the above-described specific commercial power source.

The data communication system of the present invention is a system having a portable electronic appliance made functional after being charged with electric power, and a data processor establishing data communication with at least the portable electronic appliance, and has the portable electronic appliance of the present invention, and the data processor of the present invention.

A first computer program of the present invention is a program for a portable electronic appliance having a battery-powered functional unit made functional after being charged with electric power from an external commercial power source, configured as allowing a computer to execute a data receiving process receiving, from an external specific data processor, at least a function interrupting command for the battery-powered functional unit, when the power is supplied from the specific commercial power source; a function interrupting process interrupting at least a part of functions of the battery-powered functional unit upon receiving of the function interrupting command; an account settlement receiving process executing account settlement of supplied power, while keeping the battery-powered functional unit in functional interruption; and a interruption unlock process unlocking functional interruption of the battery-powered functional unit upon completion of the account settlement.

A second computer program of the present invention is a program for a data processor establishing data communication with at least a portable electronic appliance, configured as allowing a computer to execute a data sending process sending at least a function interrupting command to the portable electronic appliance supplied with electric power from a specific commercial power source; and an account settlement executing process executing account settlement of supplied power for the portable electronic appliance to which the function interrupting command was sent.

A first data processing method of the present invention is a method for a portable electronic appliance having a battery-powered functional unit made functional after being charged with electric power from an external commercial power source, which includes a data receiving step receiving, from an external specific data processor, at least a function interrupting command for the battery-powered functional unit, when electric power is supplied from the commercial power source; a function interrupting step interrupting at least a part of functions of the battery-powered functional unit upon receiving of the function interrupting command; an account settlement accepting step executing account settlement of supplied power, while keeping the battery-powered functional unit in functional interruption; and a interruption unlock step unlocking functional interruption of the battery-powered functional unit upon completion of the account settlement.

A second data processing method of the present invention is a method for a data processor establishing data communication with at least a portable electronic appliance, which includes a data sending step sending at least a function interrupting command to the portable electronic appliance supplied with electric power from a specific commercial power source; and an account settlement executing step executing account settlement of supplied power for the portable electronic appliance to which the function interrupting command was sent.

The individual constituents of the present invention may be good enough if they are formed so as to realize their functions, and may be realized typically as a specialized hardware expressing predetermined functions, a data processor having predetermined functions assigned by a computer program, a predetermined function realized on a data processor by a computer program, and arbitrary combinations of them.

The individual constituents of the present invention may not always be independent from each other, wherein possible configurations may include that a plurality of constituents are integrated to give a single component, that a single constituent is composed of a plurality of components, that a certain constituent forms a part of other constituent, and that a part of certain constituent and a part of other constituent overlap with each other.

The data processing method of the present invention is described by sequentially enumerating a plurality of steps in order, wherein the described order of these steps never limit the order of execution of the plurality of steps. Therefore, the steps of the data processing method of the present invention may be executed in a modified order, so far as the modification will not adversely affect results of processing.

“Storing data” in the context of the present invention means that the device of the present invention has at least a function of storing data. For this reason, this allows also that the devices of the present invention store data newly registered by a consumer, and that the devices store data registered by a supplier in the process of manufacturing, but will have no data newly registered thereto by a consumer after the shipping.

The portable electronic appliance of the present invention is brought into functional interruption when electric power is supplied from a specific commercial power source, wherein the functional interruption is not unlocked until the account is settled. Therefore, if the user is supplied with electric power from a non-contracted specific commercial power source, the power rate is automatically settled. In this way, stealing of electricity by the unauthorized user may be avoidable. The above-described functional interruption is a special function of the portable electronic appliance of the present invention. Therefore, any general electric appliances connected to the above-described specific commercial power source will never be brought into functional interruption by the data processor. As a consequence, any general electric appliances may freely be connected to the specific commercial power source adapted to the portable electronic appliance of the present invention, and may be used without causing any problems.

The data processor of the present invention executes account settlement, while bringing the portable electronic appliance, supplied with electric power from the specific commercial power source, into functional interruption using the function interrupting command. When electric power is supplied from the specific commercial power source to the portable electronic appliance of an unauthorized user, the power rate is then automatically settled. In this way, stealing of electricity by an unauthorized user of the portable electronic appliance may be avoidable. The functional interruption is executed only for the specific portable electronic appliance corresponded to a predetermined function interrupting command. As a consequence, functions of the general electric appliances will never be interrupted by the data processor, even if they are connected to the above-described specific commercial power source. Therefore, any general electric appliances may freely be connected to the specific commercial power source adapted to the portable electronic appliance of the present invention, and may be used without causing any problems.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a block diagram schematically showing a logic structure of a data communication system in one embodiment of the present invention;

FIG. 2 is a schematic drawing showing a state of use of the data communication system;

FIG. 3 is a schematic front elevation showing an appearance of a mobile phone terminal as the portable electronic appliance;

FIG. 4 is a flow chart showing a data processing method executed by a data processor; and

FIG. 5 is a flow chart showing a data processing method executed by a mobile phone terminal.

### DETAILED DESCRIPTION

The invention will now be described herein with reference to an illustrative embodiment. Those skilled in the art will recognize that many alternative embodiments can be accomplished using the teachings of the present invention and that the invention is not limited to the embodiment illustrated for explanatory purposes.

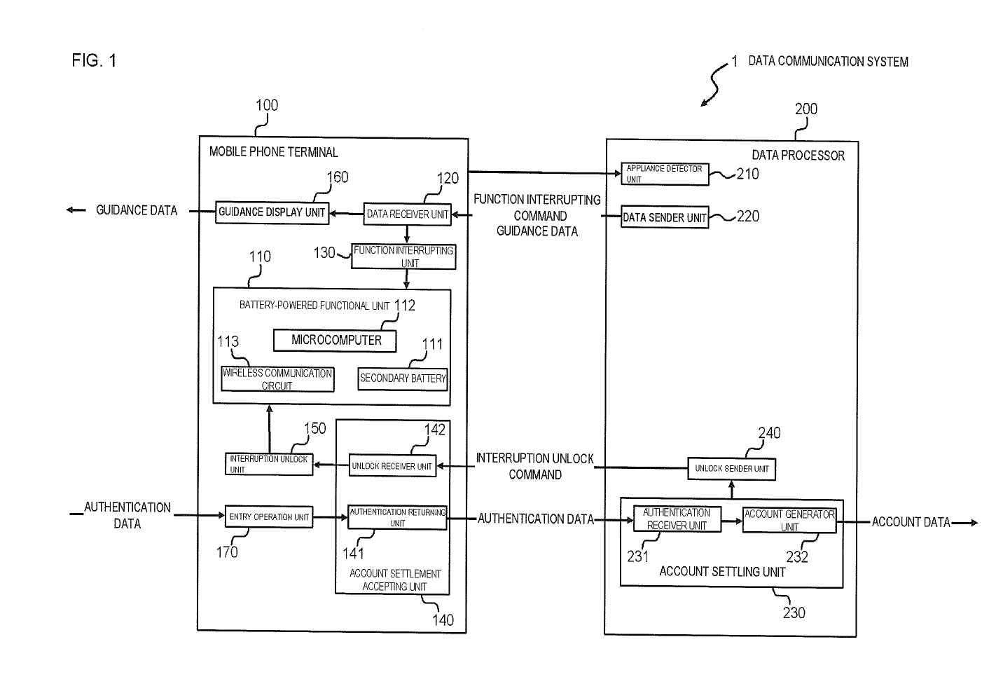

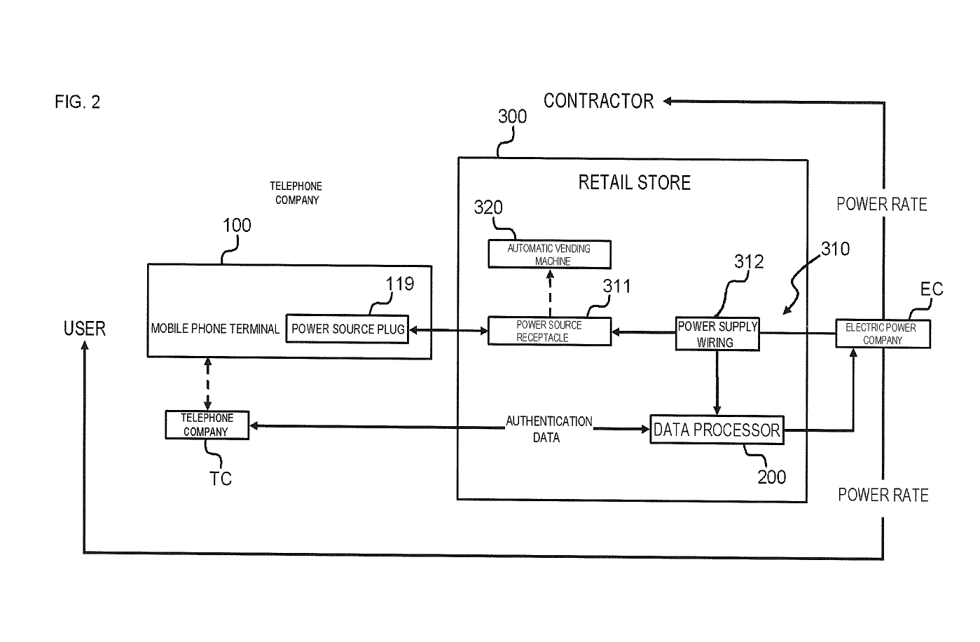

One embodiment of the present invention will be explained below, referring to the attached drawings. As shown in FIG. 1 and FIG. 2, a data communication system 1 of the present invention has a mobile phone terminal 100, which is a portable electronic appliance made functional after being charged with electric power, and a data processor 200 establishing data communication with at least a mobile phone terminal 100.

The mobile phone terminal 100 has a battery-powered functional unit 110 made functional after being charged with electric power supplied from a commercial power source 310, a data receiver unit 120 receiving, from the external data processor 200, at least a function interrupting command of the battery-powered functional unit 110 when electric power is supplied from the specific commercial power source 310, a function interrupting unit 130 interrupting at least a part of functions of the battery-powered functional unit 110 upon receiving of the function interrupting command, an account settlement accepting unit 140 executing account settlement of supplied power, while keeping the battery-powered functional unit 110 in functional interruption, and an interruption unlock unit 150 unlocking functional interruption of the battery-powered functional unit 110 upon completion of the account settlement.

The data processor 200 has an appliance detector unit 210 detecting the mobile phone terminal 100 to which electric power is supplied from the specific commercial power source 310, a data sender unit 220 sending at least a function interrupting command to the detected mobile phone terminal 100, and an account settling unit 230 executing account settlement of supplied power for the mobile phone terminal 100 to which the function interrupting command was sent.

More details, the mobile phone terminal 100 has a data processing unit (not shown), composed of a secondary battery 111, a microcomputer 112, a wireless communication circuit 113 and so forth, as the battery-powered functional unit 110.

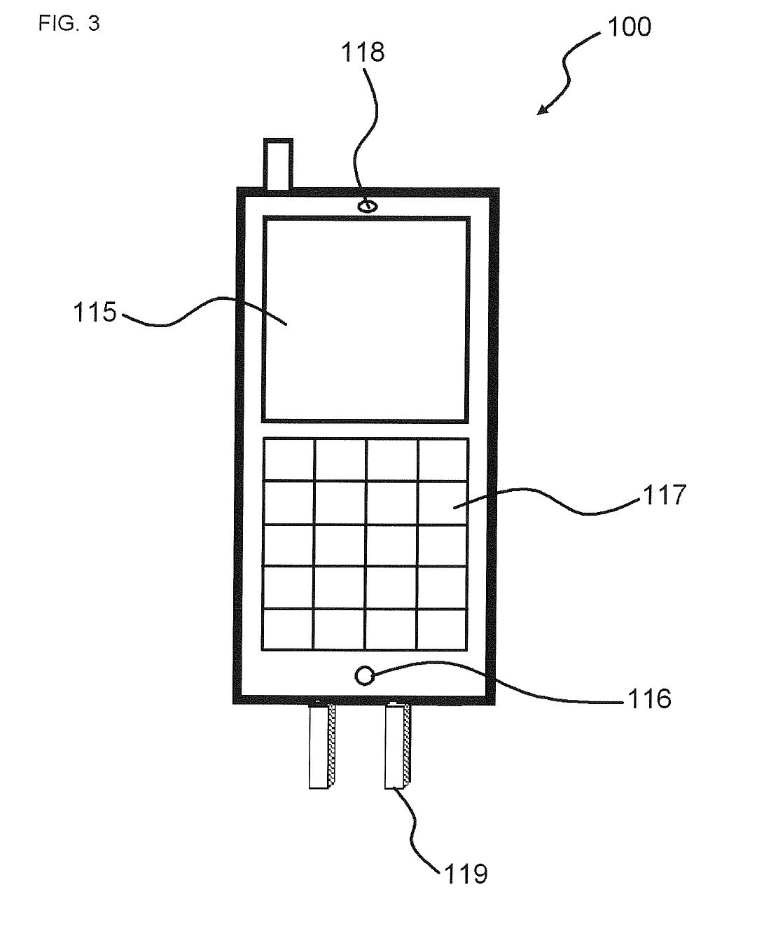

The mobile phone terminal 100 has, as shown in FIG. 3, also a display unit 115 displaying thereon various data, a loudspeaker unit 116 producing sound output of various data, a keyboard unit 117 allowing thereon entry operation of various data, and a microphone unit 118 allowing therethrough voice input of various data, and so forth.

The mobile phone terminal 100 of this embodiment has, as shown in FIG. 2 and FIG. 3, also a power source plug 119 having a general structure, aimed at receiving, from the commercial power source 310, electric power to be supplied to the secondary battery 111 of the battery-powered functional unit 110 described in the above.

The power source plug 119 is connected also to a microcomputer 112 of the battery-powered functional unit 110, and functions also as an interface for power line communication. As a consequence, the mobile phone terminal 100, detailed later, establishes data communication with the data processor 200, by power line communication via a power source receptacle 311 of the commercial power source 310.

The microcomputer 112 incorporates an appropriate computer program typically in a form of firmware. By operations such as integrated control of the various devices executed by the microcomputer 112 corresponding to the computer program, the above-described individual components 120—may be logically realized on the mobile phone terminal 100.

The mobile phone terminal 100, adapted to execution of various operations by the microcomputer 112 according to the computer program, further includes a data receiver unit 120 receiving, from the data processor 200, the function interrupting command for the battery-powered functional unit 110 and a guidance data for sending authentication used for the account settlement, a guidance display unit 160 allowing the display unit 115 to display thereon the received guidance data, an entry operation unit 170 accepting authentication data entered through the keyboard unit 117 corresponding to the displayed guidance data for sending authentication.

The account settlement accepting unit 140 has an authentication returning unit 141 sending the entered authentication data to the data processor 200, and an unlock receiver unit 142 receiving the interruption unlock command from the data processor 200 corresponding to sending of the authentication data.

The function interrupting unit 130 interrupts functions of the battery-powered functional unit 110 upon receiving of the function interrupting command. The interruption unlock unit 150 unlocks the functional interruption of the powered functional unit 110 upon receiving of the interruption unlock command.

The data processor 200 is composed of so-called personal computer and so forth, and again incorporates appropriate computer programs. By executing various process operations corresponding to the computer programs, the individual components 210—may be logically realized on the data processor 200.

As shown in FIG. 2, the data processor 200 is installed typically at a retail store 300 such as convenience store, and is used for processing of sales data in the backyard.

In the retail store 300, a power source receptacle 311 is provided typically on the exterior of the store, and an automatic vending machine 320 is plugged into the power source receptacle 311.

Also the data processor 200 is connected to the power supply wiring 312 linked to the power source receptacle 311. By virtue of this configuration, the data processor 200 establishes data communication with the mobile phone terminal 100, based on power line communication through the power source receptacle 311.

The data processor 200 further contains an unlock sender unit 240 sending the interruption unlock command to the mobile phone terminal 100 upon completion of the account settlement, by executing various operations corresponding to the computer programs installed as described in the above.

The data sender unit 220 herein sends the function interrupting command and the guidance data for sending authentication to the detected mobile phone terminal 100. The account settling unit 230 has an authentication receiver unit 231 receiving the authentication data from the mobile phone terminal 100, corresponding to sending of the guidance data, and an account generator unit 232 authenticating an user of the mobile phone terminal 100 based on the received authentication data, and generating account data.

A computer program for the mobile phone terminal 100 is described so as to allow the mobile phone terminal 100 to execute, for example, a data receiving process receiving, from an external specific data processor 200, a function interrupting command and the guidance data, when the power is supplied from the specific commercial power source 310, a function interrupting process interrupting at least a part of functions of the battery-powered functional unit 110 upon receiving of the function interrupting command, a guidance displaying process displaying the received guidance data on the display unit 115, an enter operation process accepting the authentication data entered through the keyboard unit 117 corresponding to the displayed guidance data for sending authentication, an authentication returning process sending the entered authentication data to the data processor 200, an unlock receiving process receiving the interruption unlock command from the data processor 200, corresponding to sending of the authentication data, and an interruption unlock process unlocking the functional interruption of the battery-powered functional unit 110 upon receiving of the interruption unlock command.

A computer program for the data processor 200 is described so as to allow the data processor 200 to execute an appliance detecting process detecting the mobile phone terminal 100 supplied with electric power from the specific commercial power source 310, a data sending process sending the function interrupting command and the guidance data to the detected mobile phone terminal 100, an authentication receiving process receiving the authentication data from the mobile phone terminal 100 to which the function interrupting command was sent, an account generating process authenticating an user of the mobile phone terminal 100 based on the received authentication data, and an unlock sending process sending the interruption unlock command to the mobile phone terminal 100 upon completion of generation of account data.

In the above-described configuration, the data processor 200 of this embodiment is installed at, for example, the retail store 300 such as a convenience store as shown in FIG. 2. At the retail store 300, the automatic vending machine 320 is plugged, for example, into the power source receptacle 311 on the exterior of the store.

As a matter of course, the power source receptacle 311 is supplied with electric power from an electric power company EC through the power supply wiring 312 of the commercial power source 310. The contractor of the retail store 300 therefore pays rate of consumed electric power to the electric power company EC.

Similarly, the user of the mobile phone terminal 100 makes a contract with the electric power company EC, generally at his or her home (not shown), and pays rate of electric power at his or her home to the electric power company EC. Such user generally charges the mobile phone terminal 100 by connecting it to the power source receptacle of his or her own home.

Such user also makes a contract with the telephone company TC, and pays rate of the mobile phone terminal 100. Therefore, the telephone company TC has an authentication data capable of specifying the mobile phone terminal 100 registered in the user data base (not shown).

Such user may sometimes be in need of charging when he or she is out with the mobile phone terminal 100. In this case, the user may charge the mobile phone terminal 100 by plugging its power source plug 119 into the power source receptacle 311 at the retail store 300.

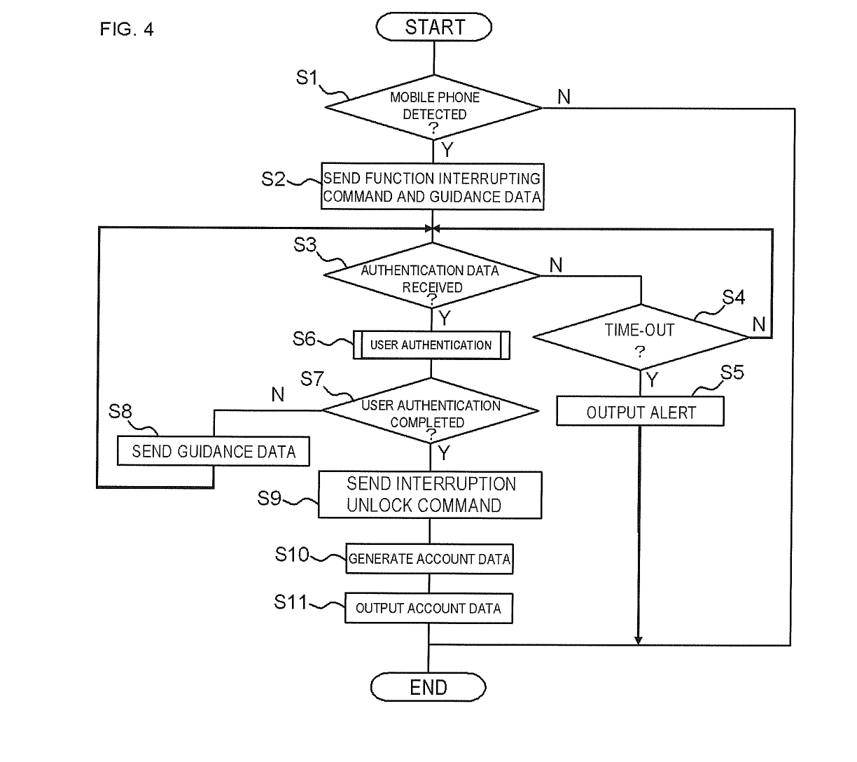

Then as shown in FIG. 4, the data processor 200 at the retail store 300, connected through the power supply wiring 312 of the power source receptacle 311, detects the mobile phone terminal 100 based on power line communication (step S1).

For example, upon detection of start of charging, the mobile phone terminal 100 of the present invention sends charging start data through the power source plug 119 based on the power line communication. If the charging start data is received by the data processor 200 based on power line communication, the mobile phone terminal 100 to be supplied with electric power is detected.

Next, the data processor 200 sends the function interrupting command and the guidance data for sending authentication to the mobile phone terminal 100, based on power line communication through the power source receptacle 311 (step S2).

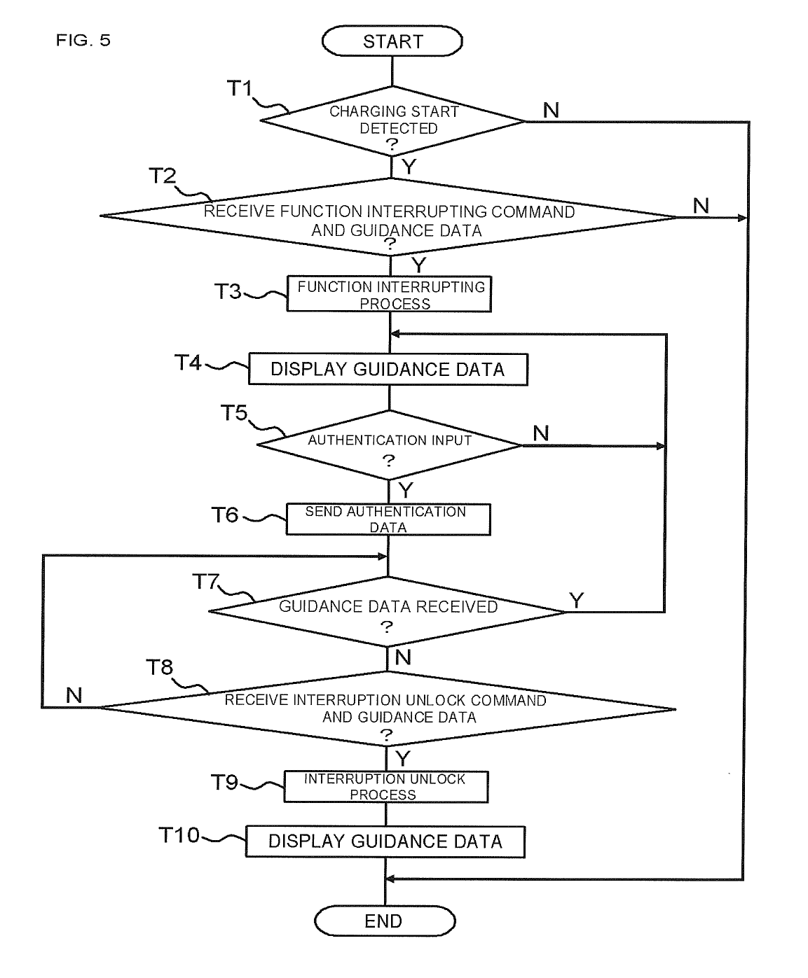

In this process, as shown in FIG. 5, the mobile phone terminal 100 began to be charged through the power source receptacle 311 (step T1), then receives the function interrupting command and the guidance data based on the power line communication as described in the above (step T2), and the wireless communication circuit 113 of the battery-powered functional unit 110 is brought into functional interruption (step T3).

The mobile phone terminal 100 may, therefore, establish power line communication with the data processor 200 without problems, while being charged with electric power through the power source receptacle 311, but is disabled in establishing wireless communication which is a major function thereof.

In this state, a guidance data, typically such as “Unauthorized charging. Wireless communication is locked. Pay power rate by sending your authentication data to unlock. Enter your authentication data registered to the telephone company.”, is displayed on the display unit 115 of the mobile phone terminal 100 (step T4).

When the user enters his or her authentication data through the keyboard unit 117 of the mobile phone terminal 100 (step T5), the authentication data is sent to the data processor 200 based on the power line communication (step T6).

Upon receiving the authentication data based on the power line communication (step S3), the data processor 200 collates the authentication data to the telephone company TC as shown in FIG. 2, and authenticates the user of the mobile phone terminal 100 (step S6).

The data processor 200 thus succeeded in authenticating the user (step S7) then sends the interruption unlock command and the guidance data indicating settlement of account to the mobile phone terminal 100, based on the power line communication (step S9).

Upon receiving of the interruption unlock command and the guidance data indicating settlement of account (step T8) based on the power line communication, the functional interruption of the wireless communication circuit 113 of the mobile phone terminal 100 is unlocked (step T9).

A guidance data, typically such as “Wireless communication recovered. This power rate is added to your power rate at your home. The additional power rate includes the commission. Thank you for your understanding on prevention of unauthorized charging.”, is displayed on the display unit 115 (step T10). The user can unplug the mobile phone terminal 100 from the power source receptacle 311, and can now use the function thereof.

The data processor 200, thus authenticating the user of the mobile phone terminal 100 as described in the above (step S7), generates account data based on the authentication data of the user (step S10). Thus-generated account data typically includes capacity and time of charging of electric power supplied to the mobile phone terminal 100, the authentication data of the contractor of the retail store 300, and so forth.

The data processor 200 sends thus-generated account data to the electric power company EC (step S11). The electric power company EC then subtracts the power rate corresponded to the account data from the power rate of the contractor, and adds it to the power rate of the user. General rate of electric power actually charged into the mobile phone terminal 100 is extremely small, and is of no merit of settling the account.

Therefore, a possible practical processing may be executed typically in such a way that the power rate for charging and the charge for using the power source receptacle 311 is subtracted from the power rate of the contractor of the retail store 300, and the power rate for charging, the above-described charge for using, and the commission to the electric power company EC are added to the power rate called upon the user of the terminal 100.

If the authentication data entered by the user through the mobile phone terminal 100, corresponding to the guidance data for sending authentication as described in the above, is inappropriate, the data processor 200 detects that the telephone company TC failed in authenticating the user, as shown in FIG. 4 (step S7).

The data processor 200 in this case sends the guidance data indicating authentication failure to the mobile phone terminal 100 based on power line communication (step S8). Then as shown in FIG. 5, a guidance data, typically such as “Authentication failed. Wireless communication remains locked. Enter your authentication data registered to the telephone company again.”, is displayed on the mobile phone terminal 100 (steps T7, T4).

The mobile phone terminal 100 in this case remains in the functional interruption because the interruption unlock command is not received. Therefore, the functional interruption will never be unlocked without appropriate authentication data entered by the user of the mobile phone terminal 100.

The data processor 200 outputs an alert data (step S5) for notification, if a predetermined length of time elapsed without detecting sending of an appropriate authentication data from the mobile phone terminal 100 (steps S3, S4).

In this case, an alert message typically such as “Unauthorized appliance detected on the external receptacle. Confirm it.”, is informed to the contractor through the display or sound of a loudspeaker, and the contractor can confirm the power source receptacle 311 on the exterior of the store.

As has been described in the above, in the data communication system 1 of this embodiment, the mobile phone terminal 100 to be supplied with electric power from the commercial power source 310 at the retail store 300 is brought into functional interruption by the data processor 200.

The power rate for charging is settled by the data processor 200, while keeping the mobile phone terminal 100 in the state of functional interruption, and the functional interruption of the mobile phone terminal 100 is unlocked upon completion of the account settlement.

Therefore, the contractor of the retail store 300 will never be asked for any unreasonable rate of electric power charged in the mobile phone terminal 100, and thereby stealing of electricity by the user of the mobile phone terminal 100 may be avoidable.

What is better, the functional interruption is executed only for a specific mobile phone terminal 100 corresponded to a predetermined function interrupting command. Therefore, any general electric appliances such as the automatic vending machine 320 plugged into the above-described specific power source receptacle 311 will never be brought into functional interruption by the data processor 200. Therefore, any general electric appliances may freely be plugged into the specific power source receptacle 311, and may be used without problems.

Moreover, in the data communication system 1 of this embodiment, the authentication data entered by the user through the mobile phone terminal 100 is collated by the data processor 200 in correspondence with the telephone company TC, the account data is generated based on the authentication data, and the account data is then sent to the electric power company EC. Therefore, the electric power company EC can rationally settle the accounts of power rate of the user of the mobile phone terminal 100 and the contractor of the retail store 300.

Data communication is established between the mobile phone terminal 100 and the data processor 200 based on the power line communication. The data processor 200 may, therefore, establish the data communication with the mobile phone terminal 100 to which electric power is charged through the power source receptacle 311, in a simple and reliable way.

Moreover, the data processor 200 executes the functional interruption, account settlement, and interruption unlocking, based on data communication with the mobile phone terminal 100. It is therefore not necessary to interrupt power supplied to the power source receptacle 311 for the purpose of preventing stealing of electricity. As a consequence, any large-scale facility is no more necessary, and also malfunction such that power supply is interrupted due to detection failure may be avoidable.

The present invention is by no means limited to this embodiment, and allows various modifications without departing from the spirit thereof. For example, the embodiment described in the above exemplified the mobile phone terminal 100 as the portable electronic appliance.

However, the portable electronic appliance may be anything so far as it is battery-powered and has functions such as data communication, and may be a PDA (personal digital assistance), portable music player, portable game machine, portable navigation system, electronic dictionary and so forth (not shown).

The above-described embodiment exemplified that the authentication data entered by the user of the mobile phone terminal 100 is sent to the data processor 200, and thereby the account settlement is executed. Another possible example is such that the authentication data registered to the telephone company TC is recorded in the mobile phone terminal in a fixed manner, and that the authentication data may be sent by enter operation by the user from the mobile phone terminal to the data processor (not shown).

More details, the mobile phone terminal as described in the above may have an authentication memory unit storing the authentication data, may accept permission for sending of the authentication data entered corresponding to the guidance data for sending authentication, and may send the authentication data to the data processor 200, corresponding to enter operation of the permission for sending.

In this case, the user of the mobile phone terminal is exempt from entering complicated authentication data. The data processor will never fail in authentication process or account settlement, because any unauthorized authentication data will never be sent.

Because any unauthorized authentication data will never be sent as described in the above, the mobile phone terminal may unlock the functional interruption by itself, upon sending of the stored authentication data. The data processor in this case is not asked for sending the interruption unlock command.

The authentication data described in the above may be so-called credit data or debit data. In this case, the account settlement may directly be executed using the authentication data. This type of account settlement may be executed as a demand for payment from the contractor of the retail store 300 to the user of the mobile phone terminal 100.

Still another possible configuration is such that the mobile phone terminal has a authentication memory unit storing electronic money, and is capable of receiving and displaying guidance data of electronic payment, accepting a permission for account settlement entered corresponding to the guidance data of the displayed electronic payment, sending the entered permission for account settlement to the data processor 200, accepting electronic payment of electronic money by the data processor 200 corresponded to sending of the permission for account settlement, and of receiving the interruption unlock command from the data processor 200 corresponding to completion of the electronic payment.

In this case, the data processor can settle the power rate using the electronic money recorded in the mobile phone terminal. Therefore the data processor is not asked for authenticating the user of the mobile phone terminal.

Still another possible configuration is such that the mobile phone terminal accepts the electronic payment using the electronic money by the data processor 200 corresponded to sending of the permission for account settlement, and unlocks the functional interruption by itself upon completion of the electronic payment, without receiving the interruption unlock command. Of course, the data processor may present the above-described various methods of account settlement at a time, and allow the user to select any one of them.

The above-described embodiment showed an exemplary case where the data processor 200 output the alert data to the contractor, if it failed in detecting and authenticating the mobile phone terminal 100. However, it may be assumed even that an unauthorized user intermittently plugs the mobile phone terminal 100 into the power source receptacle 311 to thereby charge the terminal, skipping data processing for detection and authentication.

Then, for the purpose of detecting the unauthorized charging, a possible configuration may be such that the data processor detects the intermittent power supply from the commercial power source by pattern recognition, and outputs alert data to the contractor.

The above-described embodiment showed an exemplary case where the account data was sent from the data processor 200 to the electric power company EC, the power rate was added to the power rate of the user of the mobile phone terminal 100, and concomitantly subtracted from the power rate of the contractor of the retail store 300. Alternatively, the telephone company TC may be asked for the power rate by the electric power company EC, and the telephone company TC may add the power rate to the telephone rate of the user of the mobile phone terminal 100.

Still alternatively, the above-described account data may be sent from the data processor 200 to the telephone company TC. In this case, the telephone company TC may add the power rate to the telephone rate of the user of the mobile phone terminal 100, and may concomitantly subtract it from the telephone rate of the contractor of the retail store 300. Still alternatively, the above-described power rate may be paid by the telephone company TC to the electric power company EC, and the electric power company EC may subtract it from the power rate of the contractor of the retail store 300.

The above-described embodiment showed an exemplary case where the authentication data output from the mobile phone terminal 100 was sent from the data processor 200 to the telephone company TC. Alternatively, the mobile phone terminal remotely controlled by the data processor may send the authentication data to the telephone company by wireless communication. In this case, the mobile phone terminal is allowed to authenticate itself, and result of the authentication may be acquired by the data processor.

The above-described embodiment showed an exemplary case where the data processor 200 communicating with the mobile phone terminal 100 through the power line did not control electric power. Alternatively, the data processor may temporarily interrupt power supply to the detected mobile phone terminal 100, and may restart the temporarily interrupted power supply upon completion of the account settlement.

In this case, stealing of electricity may be avoidable in more reliable manner, while raising a need of providing an additional facility for power control, and a fear of interruption of power supply due to erroneous detection. For the purpose of ensuring the power supply to rational appliance without problems while preventing erroneous detection, the data communication system in this case may preferably be configured so that the data processor can authenticate the electric appliance. This sort of process may be difficult for general electric appliances, but may be easy for the professional-use machines such as the automatic vending machine 320.

The above-described embodiment showed an exemplary case where the power source receptacle 311 was provided on the exterior of the retail store 300, and the data processor 200 composed of a personal computer was connected thereto.

Alternatively, this sort of data processor and the power source receptacle may be installed in a building, or the data processor may be provided as a receptacle unit, distribution panel, breaker unit or the like, in a form of specialized hardware (not shown).

Still alternatively, the above-described embodiment showed an exemplary case where the mobile phone terminal 100 and the data processor 200 were brought into data communication based on power line communication through the power source receptacle 311, in a simple and reliable manner.

The data processor may, however, be anything provided that it can exactly detect the mobile phone terminal to be charged with electric power from the commercial power source, and can establish data communication therewith, and allows also wireless communication such as infrared communication and Bluetooth communication. In this case, for example, an optical unit for infrared communication may be disposed between the center of the power source plug of the mobile phone terminal and the center of the power source receptacle (not shown).

The above-described embodiment showed an exemplary case where, upon detection of start of charging, the mobile phone terminal 100 sent the charging start data through the power source plug 119 based on the power line communication, and the data processor 200 detected charging by the mobile phone terminal 100, and sent the function interrupting command.

Alternatively, the function interrupting command may be sent full-time to the power source receptacle, instead that the mobile phone terminal sends the charging start data, without detection of the mobile phone terminal by the data processor (not shown).

Alternatively, the data processor may recognize full-time the automatic vending machine plugged into the power source receptacle, and function interrupting command may be sent only when the automatic vending machine is not recognized, wherein the function interrupting command may be sent after detecting electric appliances other than the automatic vending machine based on power capacitance (not shown).

The above-described embodiment showed an exemplary case where the power source plug 119 was mounted directly to the mobile phone terminal 100. Alternatively, the mobile phone terminal may have a separately-available adapter for charging, and through such adapter for charging, the mobile phone terminal may be connected to the commercial power source. In this case, the adapter for charging may mediate data communication between the mobile phone terminal and the data processor, and a part of the data communication or data processing may be executed by the adapter for charging.

Still alternatively, the above-described embodiment showed an exemplary case where the whole guidance data was sent from the data processor 200 to the mobile phone terminal 100. Alternatively, text data composing the guidance data may be stored in the mobile phone terminal, and the display command thereof may be sent from the data processor to the mobile phone terminal.

The above-described embodiment showed an exemplary case where the data processor 200 was plugged into the power source receptacle 311 to which the mobile phone terminal 100 is connected, based on power line communication. Alternatively, this sort of data processor may be installed at the electric power company or at the telephone company (not shown).

For example, the power source receptacle may preliminarily be provided with an RFID (radio frequency identification) chip, wherein the mobile phone terminal may detect the chip using an RFID reader, and may post the detection to the data processor installed typically at the telephone company, based on wireless communication.

In this case, the data processor may recognize, based on RFID data, that the mobile phone terminal was plugged into an inappropriate power source receptacle. The data processor herein may execute functional interruption, account settlement and so forth while establishing wireless communication with the mobile phone terminal, and may return the power rate by specifying the contractor of the power source receptacle, based on the RFID data.

At present, general mobile phone terminals may be charged when the main units thereof are powered off. However, the data processor cannot execute functional interruption and so forth, if the mobile phone terminal in the powered-off state is plugged into the power source receptacle.

To avoid this non-conformity, it may be preferable that the main unit of the mobile phone terminal is forcedly turned on upon start of charging, or predetermined functions including functional interruption may be kept in full-time operation even when the main unit of the mobile phone terminal is turned off (not shown).

The embodiment showed that the individual components of the data processor may logically be realized as various functions by a computer program. Alternatively, each of the individual components may be formed as a dedicated hardware, or the data processor may be realized a combination of software and hardware.

Of course, the above-described embodiments and a plurality of modified examples may be combined so far as the details thereof may not contradict with each other. Structures of the individual components, specifically explained in the above-described embodiments and modified examples, may be modified in various ways so far as the functions of the present invention may be satisfied. It is apparent that the present invention is not limited to the above embodiment that may be modified and changed without departing from the scope and spirit of the invention.

What is claimed is:

1. A portable electronic appliance made functional after being charged with electric power, comprising:
a battery-powered functional unit made functional after being charged with electric power supplied from an external commercial power source;
a data receiving unit receiving, from an external specific data processor, at least a function interrupting command for said battery-powered functional unit, when electric power is supplied from said specific commercial power source;
a function interrupting unit interrupting at least a part of functions of said battery-powered functional unit upon receiving of said function interrupting command;
an account settlement accepting unit executing account settlement of supplied power, while keeping said battery-powered functional unit in functional interruption; and
an interruption unlock unit unlocking functional interruption of said battery-powered functional unit upon completion of said account settlement.

2. The portable electronic appliance as claimed in claim 1,
wherein said data receiving unit receives said function interrupting command and a guidance data for said account settlement from said data processor,
further comprising a guidance display unit displaying thereon said received guidance data, and an enter operation unit accepting a predetermined enter operation corresponding to said displayed guidance data, and
said account settlement accepting unit executes said account settlement corresponding to the enter operation.

3. The portable electronic appliance as claimed claim 2,
wherein said data receiving unit receives said function interrupting command and said guidance data for sending authentication,
said enter operation unit receives authentication data entered corresponding to said displayed guidance data for sending authentication,
said account settlement accepting unit further comprises an authentication returning unit sending said entered authentication data to said data processor, and an unlock receiver unit receiving an interruption unlock command from said data processor corresponding to sending of said authentication data, and
said interruption unlock unit unlocks functional interruption of said battery-powered functional unit upon receiving of said interruption unlock command.

4. The portable electronic appliance as claimed in claim 2, further comprising an authentication memory unit storing therein authentication data,
said data receiving unit receives said function interrupting command and said guidance data for sending authentication,
said enter operation unit accepts permission for sending said authentication data entered corresponding to said displayed guidance data for sending authentication,
said account settlement accepting unit further comprises an authentication returning unit sending said authentication data to said data processor corresponding to enter operation of said permission for sending, and an unlock receiver unit receiving an interruption unlock command from said data processor corresponding to sending of said authentication data, and
said interruption unlock unit unlocks functional interruption of said battery-powered functional unit upon receiving of said interruption unlock command.

5. The portable electronic appliance as claimed in claim 2, further comprising an authentication memory unit storing authentication data,
wherein said data receiving unit receives said function interrupting command and said guidance data for sending authentication,
said enter operation unit accepts said permission for sending the authentication data entered corresponding to the said displayed guidance data for sending authentication,
said account settlement accepting unit sends said authentication data to said data processor corresponding to enter operation of said permission for sending, said interruption unlock unit unlocks functional interruption of said battery-powered functional unit upon sending of said authentication data.

6. The portable electronic appliance as claimed in claim 2, further comprising an authentication memory unit storing electronic money,
wherein said data receiving unit receives said function interrupting command and said guidance data of electronic payment,
said enter operation unit accepts permission for account settlement entered corresponding to said displayed guidance data of electronic payment;
said account settlement accepting unit further comprises a permission sender unit sending said entered permission for account settlement to said data processor, an account settlement accepting unit accepting electronic payment of said electronic money by said data processor corresponding to sending of said permission for account settlement, and an unlock receiver unit receiving an interruption unlock command from said data processor corresponding to completion of said electronic payment, and
said interruption unlock unit unlocks functional interruption of said battery-powered functional unit, upon receiving of said interruption unlock command.

7. The portable electronic appliance as claimed in claim 2, further comprising an authentication memory unit storing electronic money,
said data receiving unit receives said function interrupting command and said guidance data of electronic payment,
said enter operation unit accepts permission for account settlement entered corresponding to said displayed guidance data of electronic payment,
said account settlement accepting unit further comprises a permission sender unit sending said entered permission for account settlement to said data processor, and an account settlement accepting unit accepting electronic payment of said electronic money by said data processor corresponding to sending of said permission for account settlement, and
said interruption unlock unit unlocks functional interruption of said battery-powered functional unit upon completion of electronic payment.

8. The portable electronic appliance as claimed in claim 1, establishing data communication with said data processor by power line communication through a power source receptacle of said commercial power source.

9. A data processor establishing data communication at least with a portable electronic appliance, comprising:
a data sender unit sending at least a function interrupting command to said portable electronic appliance supplied with electric power from a specific commercial power source; and
an account settlement executing unit executing account settlement of supplied power for said portable electronic appliance to which said function interrupting command was sent.

10. The data processor as claimed in claim 9,
wherein said data sender unit sends said function interrupting command and a guidance data for said account settlement to said detected portable electronic appliance, and
said account settlement executing unit executes said account settlement for said portable electronic appliance corresponding to sending of said guidance data.

11. The data processor as claimed in claim 9, further comprising an unlock sender unit sending an interruption unlock command to said portable electronic appliance upon completion of said account settlement.

12. The data processor as claimed in claim 10,
wherein said data sender unit sends said function interrupting command and said guidance data for sending authentication to said detected portable electronic appliance, and
said account settlement executing unit further comprises an authentication receiver unit receiving an authentication data from said portable electronic appliance corresponding to sending of said guidance data, and an account generator unit authenticating an user of said portable electronic appliance based on said received authentication data, and generating account data.

13. The data processor as claimed in claim 10,
wherein said data sender unit sends said function interrupting command and said guidance data of electronic payment to said detected portable electronic appliance, and
said account settlement executing unit further comprises a permission receiver unit receiving permission for account settlement from said portable electronic appliance corresponding to sending of said guidance data, and an account settling unit executing electronic payment of electronic money stored in said portable electronic appliance corresponding to receiving of said permission for account settlement.

14. The data processor as claimed in claim 9, further comprising a supply interrupting unit temporarily interrupting the power supply to said detected portable electronic appliance, and
a supply re-starting unit re-starting the temporarily interrupted power supply upon completion of said account settlement.

15. The data processor as claimed in claim 9, establishing data communication with said portable electronic appliance by power line communication through a power source receptacle of said commercial power source.

16. The data processor as claimed in claim 9, further comprising:
a pattern detector unit detecting unauthorized power supply from said commercial power source by pattern recognition; and
an alerting unit outputting a predetermined alert data upon detection of unauthorized power supply.

17. A data communication system comprising a portable electronic appliance made functional after being charged with electric power, and a data processor establishing data communication with at least the portable electronic appliance,
wherein said portable electronic appliance is such as that described in claim 3, and
said data processor is such as that described in claim 12.

18. A data communication system comprising a portable electronic appliance made functional after being charged with electric power, and a data processor establishing data communication with at least the portable electronic appliance,
wherein said portable electronic appliance is such as that described in claim 6, and
said data processor is such as that described in claim 13.

19. A computer program for a portable electronic appliance having a battery-powered functional unit made functional after being charged with electric power from an external commercial power source, configured as allowing the portable electronic appliance to execute:
a data receiving process receiving, from an external specific data processor, at least a function interrupting command for said battery-powered functional unit, when the power is supplied from said specific commercial power source;
a function interrupting process interrupting at least a part of functions of said battery-powered functional unit upon receiving of said function interrupting command;
an account settlement receiving process executing account settlement of supplied power, while keeping said battery-powered functional unit in functional interruption; and
a interruption unlock process unlocking functional interruption of said battery-powered functional unit upon completion of said account settlement.

20. A computer program for a data processor establishing data communication with at least a portable electronic appliance, configured as allowing the data processor to execute:
a data sending process sending at least a function interrupting command to said portable electronic appliance supplied with electric power from a specific commercial power source; and
an account settlement executing process executing account settlement of supplied power for said portable electronic appliance to which said function interrupting command was sent.

21. A data processing method for a portable electronic appliance having a battery-powered functional unit made functional after being charged with electric power from an external commercial power source, comprising:
a data receiving step receiving, from an external specific data processor, at least a function interrupting command for said battery-powered functional unit, when electric power is supplied from said commercial power source;
a function interrupting step interrupting at least a part of functions of said battery-powered functional unit upon receiving of said function interrupting command;
an account settlement accepting step executing account settlement of supplied power, while keeping said battery-powered functional unit in functional interruption; and
a interruption unlock step unlocking functional interruption of said battery-powered functional unit upon completion of said account settlement.

22. A data processing method for a data processor establishing data communication with at least a portable electronic appliance, comprising:
a data sending step sending at least a function interrupting command to said portable electronic appliance supplied with electric power from a specific commercial power source; and
an account settlement executing step executing account settlement of supplied power for said portable electronic appliance to which said function interrupting command was sent.
